(19) United States
(12) Patent Application Publication
(10) Pub. No.: US 2006/0233368 A1
(43) Pub. Date: Oct. 19, 2006

(54) Method for conditional access in a DMTS/DOCSIS enabled set top box environment

(76) Inventor: Gordon Thompson, Alpharetta, GA (US)

Correspondence Address: ARRIS INTERNATIONAL, INC, 3871 LAKEFIELD DRIVE, SUWANEE, GA, 30024, US

(21) Appl. No.: 11/395,589

(22) Filed: Mar. 30, 2006

Related U.S. Application Data
(60) Provisional application No. 60/666,435, filed on Mar. 30, 2005.

(51) Int. Cl. H04N 7/167

(52) U.S. Cl. 380/210

(57) ABSTRACT

The DOCSIS portion of a composite subscriber device is coupled to a video device. The DOCSIS portion ranges and obtain a symmetric session key generated and encrypted using the DOCSIS portion's private key, and broadcast from a central network device over a data channel. The session key is decrypted using the device's DOCSIS private key. The DOCSIS portion forwards the session key to a video control processor, which uses the session key to decrypt encrypted video control messages received by the video portion of the composite device over a video channle. The decrypted video control messages are used to process video content signals received at the composite subscriber device over the video channel.

### CROSS REFERENCE TO RELATED APPLICATION

This application claims priority under 35 U.S.C. 119(e) to U.S. provisional patent application No. 60/666,435 entitled “Method for conditional access in a DMTS/DOCSIS enabled set top box environment,” which was filed Mar. 30, 2005, and is incorporated herein by reference in its entirety.

### FIELD OF THE INVENTION

This invention relates, generally, to communication networks and devices and, more particularly, to transmitting permissive messages for use by one device using a communication channel used by another device.

### BACKGROUND

Data-Over-Cable Service Interface Specifications (“DOCSIS”) has been established by cable television network operators to facilitate transporting data traffic, primarily internet traffic, over existing community antenna television (“CATV”) networks. In addition to transporting data traffic as well as television content signals over a CATV network, multiple services operators (“MSO”) also use their CATV network infrastructure for carrying voice, video on demand (“VoD”) and video conferencing traffic signals, among other types.

Many MSOs offer premium services, such as, for example, premium movie channels, pay per view and video on demand. To obtain such services, a set top box typically uses a smart card that has been programmed with subscriber preferences that indicate what content a user/subscriber has paid for, i.e., which premium services are associated with his or her account. Alternatively, a subscriber's set top box may have an IP address connected to an internetwork, such as the Internet. Video control messages, sometimes referred to as entitlement control messages (“ECM”), can thus be sent to the set top box according to the IP address or, based on an identifier in the smart card. The ECMs are then used to decrypt premium content signals. However, smart cards are costly and sending messages via IP may be slow, unreliable and inefficient. Furthermore, if a hacker unlawfully obtains an ECM and distributes it to many subscribers, potentially all subscribers connected to a given MSO may be able to illegally obtain premium content. Thus, there is a need in the art for a method and system for providing video control messages that is cost efficient, is relatively secure and will not result in widespread delivery of content to nonpaying subscribers if security is breached.

### SUMMARY

The DOCSIS cable modem (“CM”) portion of a set top box registers with the CMTS or DMTS. CM BPI+ Exchange Authorization request is used to send authorization request with MAC Address, RSA Public Key X.509 Certificate, Security Capabilities and Security Association Identifier/Primary SID. The authorization reply contains an authorization key and a list of Security Association descriptor(s) that are encrypted with the CM's RSA public key. During a BPI+ Exchange Traffic Key Request, the CM sends a traffic key request for each of its Security Association IDs. The message is authenticated by an HFAC keyed hash derived from the authentication key. During the BPI+ Exchange Traffic Key Response, the DMTS sends Traffic Encryption Keys (TEK) for each of the authorized SAIDs. The TEKs are triple DES encrypted with a key encryption key derived from the Authorization key. This message is signed/authenticated with the HMAC keyed hash using the Message Authentication Key derived from the authentication key.

At this stage the Cable Modem Portion of the DOCSIS Enabled Set top Box is Authenticated and Authorized to provide High Speed Data service in a secure manner. Note that it is the responsibility of the embedded Cable Modem to periodically reauthorize the Authentication and Traffic encryption Keys prior to their expiration. The DMTS communicates the time to live of the keys along with the encryption keys. The Audio Visual section of the set top box is Authenticated/Authorized in a similar manner as follows. A Control Processor sends an Audio Visual Authorization request with Audio Visual Serial number, The Audio/Visual RSA Public Key X.509 Certificate, Security Capabilities and Security Association Identifier. This is sent to the DMTS via the Embedded DOCSIS CM. The DMTS sends an Audio Visual Authorization Reply by querying an entitlement management Operations Support System to determine if the Audio Visual serial number is authorized and to determine channel entitlements. If Authenticated and Authorized the DMTS sends an Authorization reply containing: An Authorization Key, a list of Security Association descriptor's, encrypted with the Audio Visual Section's RSA public key.

The Control Processor sends a Traffic Key Request for each of its Security Association IDs. The message is authenticated by an HFAC keyed hash derived from the authentication key provided in the Authorization Reply. Then, the an Audio Visual Traffic Key Response is transmitted to the set top box. The DMTS checks the HMAC hash to validate the Traffic Key request. If authenticated, the DMTS sends Traffic Encryption Keys (TEK) for each of the authorized SAIDs. The TEKs are triple DES encrypted with a key encryption key derived from the Authorization key. This message is signed/authenticated with the HMAC keyed hash using the Message Authentication Key derived from the Authentication Key provided in the Authorization Reply.

Now the Audio Visual Portion of the DOCSIS Enabled Set top Box is Authenticated and Authorized to provide Audio Visual service for those channels subscribed by the subscriber. Note that it is the responsibility of the Audio Visual Control Processor to periodically refresh the Authentication and Traffic encryption Keys prior to their expiration (the DMTS communicates the time to live of these keys along with the encryption keys. Now that the traffic keys have been successfully provided by the DMTS to the DSB. The encrypted Entitlement Management Messages can be decrypted using these TEKs on the conditional access block and be applied to the Audio Visual stream to which the subscriber is authorized.

### BRIEF DESCRIPTION OF DRAWINGS

FIG. 1 illustrates a block diagram of a system for using ECMs obtained via DOCSIS.

FIG. 2 illustrates a flow diagram for providing ECMs via DOCSIS for use in obtaining premium content.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

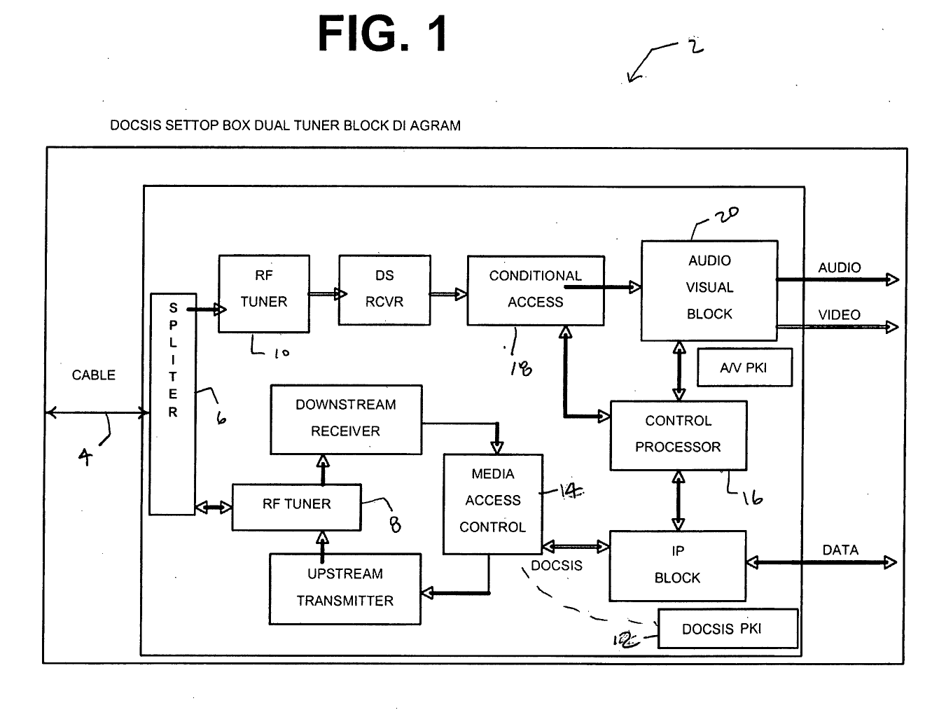

Turning to FIG. 1, a system 2 for processing data and video signals for delivery to a subscriber is shown. System 2 may comprise a composite subscriber device, have separate sections. One section may include DOCSIS processing circuitry and the other video QAM processing. Such a subscriber device may be used by cable MSOs that deliver video, voice and data services over a single cable 4, typically a coaxial cable at the subscriber's premises. The incoming signal is split by splitter 6 with part of the incoming signal forwarded to DOCSIS RF tuner 8 and part forwarded to video RF tuner 10. It will be appreciated that each of tuners 8 and 10 can tune to different channel frequencies independently of the other. Typically, all downstream signals present at cable 4 are broadcast to all subscribers connected to the MSO's head end equipment, such as the KEYSTONE D5 DMTS marketed by ARRIS International, Inc. Thus, unless methods are used to conditionally allow access of premium content to subscribers who have paid for such service and deny it to those who have not, everyone connected to the MSO's head end equipment would be capable of receiving all premium content intended only for those how have paid for it.

At the head end, a symmetric session key is encrypted using the public key that is the complement of the DOCSIS private key embedded in the composite device 2. The public/private key pair is described further in reference to BPI+ security according to the DOCIS specification, and need not be described further herein. When this encrypted session key is sent downstream from the head end, all subscribers receiving the same feed as is present on cable 4 are presented with the encrypted session key. However, only multimedia access control (“MAC”) portion of device 2 can decrypt the session key using private key 12. Thus, all other subscriber devices similar to device 2 will discard packets containing the session key encrypted with private key 12. Similarly, device 2 will discard all encrypted session keys that are encrypted with the private keys associated with other similar devices.

The decrypted session key is forwarded to the control processor 16, which uses the session key to decrypt ECM messages that are received in packets over cable 4 on a channel frequency tuned by video tuner 10. The ECMs are decrypted using the symmetric session key at conditional access block 18. Once decryption is performed, a session is established between conditional access block 18 and the head end equipment. Digital video content packets are forwarded to audio/visual processor 20 for processing into analog or digital video and/or signals for output to television or audio equipment. Thus, the MSO can set a given session key to expire within a predetermined amount of time, but typically far longer than an ECM period, which, for example, can be as short as two seconds. However, after a session is established, the session key is used to repeatedly decode new ECMs that allow the subscriber to keep watching content delivered over the same session (same premium movie channel, for example). It will be appreciated that the multiple content channels may be delivered over the same RF channel, so video tuner 10 may not change, even if the subscriber accesses another content channel, as in changing from HBO to Showtime, for example.

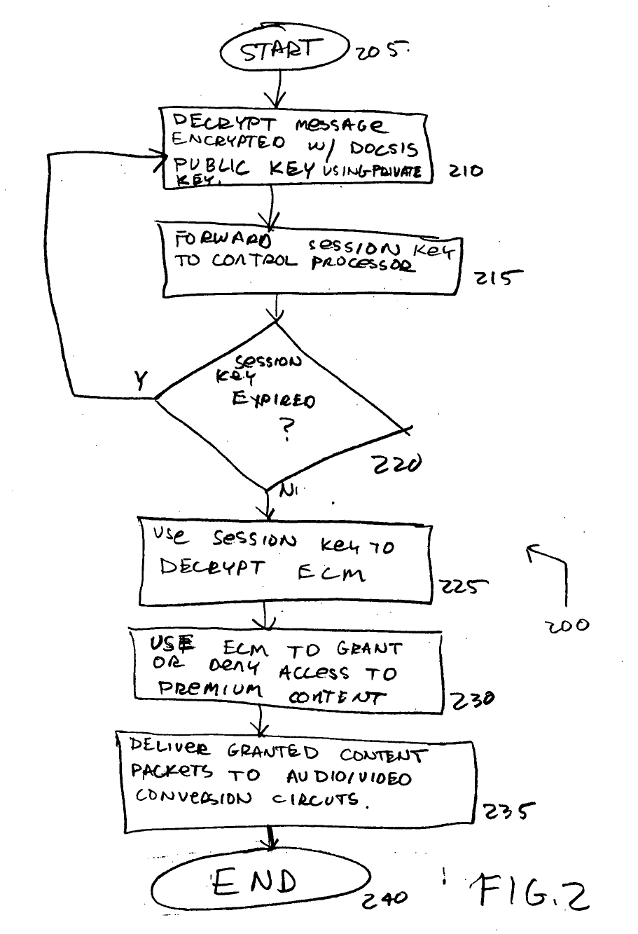

Turning now to FIG. 2, a flow diagram illustrating a method for using a subscriber device's DOCSIS private key for granting access to content is illustrated. Method 200 starts at step 205 where digital signals that are broadcast to all subscribers of a given MSO are present at the input to a dual tuner subscriber device. DOCSIS messages containing encrypted data are decrypted using the device's private key at step 210. If the decrypted data includes a symmetric video session key, the symmetric key is forwarded at step 215 to a control processor for controlling access to premium video content, which may be received on a different channel frequency than the DOCSIS channel frequency used by the dual tuner, (or possibly more than two tuners) device.

The control processor check to determine whether the session key has expired or not at step 220. This may be determined based on a time stamp contained in the session key, or the packet in which it was delivered. If the session key has expired, method 20 returns to step 210 and attempts to decrypt another message using the DOCSIS private key. If the session key is determined to still be active at step 220, the symmetric session key is used at step 225 to decrypt ECM messages received over the channel frequency to which the video tuner of the multi tuner device is tuned. The decrypted ECM messages are used to decode/decrypt content signals (typically digital packets) that correspond to the ECM at step 230. However, content that is not associated with the ECM will be denied at step 230. After content signals/packets are decoded, they are forwarded to audio/video processing circuitry at step 235 to be provided in a format usable by the subscriber. The process ends at step 240.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for delivering video control messages to a composite subscriber device having a video device coupled to a DOCSIS device, comprising:
ranging the DOCSIS device with a central network device, wherein authentication protocols are used to ensure secure transmission of information;
generating a symmetric session key at the central network device;
encrypting the session key with a public key of the DOCSIS device;
broadcasting the encrypted session key to the DOCSIS device over a first channel at a first frequency;
decrypting the session key at the DOCSIS device using the DOCSIS device's private key;
using the session key to decrypt encrypted video control messages; and
using the decrypted video control messages to process video content signals received at the composite subscriber device over the second channel at the second frequency.

2. The method of claim 1 further comprising providing the decrypted session key from the DOCSIS device to the video device.

3. The method of claim 2 wherein the encrypted video control messages are transmitted to the composite subscriber device over a second channel at a second frequency.
